(19) United States
(12) Patent Application Publication
(10) Pub. No.: US 2010/0216002 A1
(43) Pub. Date: Aug. 26, 2010

(54) FILM CASE TYPE ELECTRICITY STORAGE DEVICE

(75) Inventor: Kazuyuki Tanino, Tsukuba (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED, Tokyo (JP)

(21) Appl. No.: 12/711,428

(22) Filed: Feb. 24, 2010

(30) Foreign Application Priority Data
Feb. 26, 2009 (JP) 2009-044507

(51) Int. Cl. H01M 6/10

(52) U.S. Cl. 429/94

(57) ABSTRACT

A film-case-type electricity storage device 10 is one storing an electrode group 6 where the cross-section cut in a direction vertical to a winding axis is formed in flat-shape and two square bar-type reinforcing members 11 in a film case 12, and is capable of avoiding deformation of the electrode group 6 inside the film case, even when stress is added to the film-case-type electricity storage device 10 from the outside, by providing with the square bar-type reinforcing members 11 along the both peripheries of the electrode group 6.

### FIELD OF THE INVENTION

The present invention relates to a film-case-type electricity storage device. For detail, the present invention relates to a film-case-type electricity storage device such as a secondary battery having an electrode group containing an electrode sheet and a separator, and a capacitor.

A electricity storage device such as a condenser, a capacitor and a battery is expected in application as a power source for a mobile electronic device or a power source for an automobile. In particular, demand of a lithium ion secondary battery has been increasing in recent years as a power source for a mobile phone or a notebook-type personal computer, or a power source for an automobile.

These electricity storage devices are generally used in a sealed state, by storing the electrode group produced by laminating and winding two kinds of the electrode sheets via a separator in an arbitrary shape (a winding-type electrode group), or the electrode group produced by lamination thereof (a lamination-type electrode group) inside the case, and after charging an electrolytic solution.

In accordance with increasing capacity of the above electricity storage device associated with enhancing performance of electronic devices and automobiles, it has been regarded as important to enhance the safety thereof. Because the above electrode group is constituted by a thin sheet-like material, a can made of a metal such as stainless steel or aluminum with high mechanical strength has been used conventionally, as a case of these electricity storage devices. However, as for these metallic cans, weight of the constituent material itself, that is, specific gravity has been a large restriction in attaining a lighter electricity storage device.

Accordingly, in order to attain weight reduction, there has been proposed use of a film case composed of an airtight metal-laminated resin film instead of the metallic can (for example, JP-A-2008-53212).

FIG. 7 illustrates a schematic drawing of a conventional film-case-type electricity storage device using a film case. In the film-case-type electricity storage device 40, a winding-type electrode group 41, where a positive electrode sheet adhered with an electrode tab 43a, a negative electrode sheet adhered with an electrode tab 43b, and a separator are wound, and the cross-section cut in a direction vertical to a winding axis is formed in flat-shape, are stored in a film case 42 composed of a metal laminated resin. The electricity storage device (the film-case-type electricity storage device) using such a film case as an external packaging is used as the above power source, due to being light weight and having a good heat dissipation efficiency.

### SUMMARY OF THE INVENTION

However, as compared with the case where the metallic can is used as a case of the electricity storage device, because the metal-laminated resin film is inferior in mechanical strength, and in addition, in the case of receiving impact or stress from outside, the case shape is liable to deform because of its flexibility, resulting in a deformation of the electrode group inside the case as well, and by fracture of the electrode sheet or the separator constituting the electrode group, there is a worry of easy generation of shortcircuit. In particular, in the case of the winding-type electrode group, because of the curvature of the periphery of the electrode group, there is a worry of easy fracture of the structure caused by deformation.

It is an object of the present invention to provide the film-case-type electricity storage device capable of being produced easily and having higher mechanical strength as compared with the conventional ones, without impairing the advantage of light weight by using the film case as the external packaging.

A first aspect of the present invention to solve the problem is one relating to a film-case-type electricity storage device, made by storing an electrode group obtained by laminating or laminating and winding a first electrode sheet, a second electrode sheet and a third sheet, and a bar-like reinforcing member provided along the periphery of the electrode group, into an airtight film case. It should be noted that in the electrode group obtained, the first electrode sheet and the second electrode sheet are isolated by the third sheet.

By taking such a configuration, the deformation of the electrode group can be suppressed due to enhanced mechanical strength by the reinforcing member provided along the periphery of the electrode group. In addition, because the reinforcing member is arranged only at the periphery of the electrode group, and the whole part of the electrode group is not covered, even when the electrode group emits heat by charging-discharging the electricity storage device, heat dissipation is not disturbed.

Here, although, as a configuration of the electrode group, there are the electrode group obtained by laminating or laminating and winding the first electrode sheet, the second electrode sheet and the third sheet (the winding-type electrode group), and the electrode group obtained by laminating them (the laminating-type electrode group), the present invention is particularly suitable for the film-case-type electricity storage device using the winding-type electrode group, where a relatively compact size and heat dissipation property are required.

It should be noted that the bar-like reinforcing member may have any shape as long as it matches to the shape of the periphery of the electrode group, and a straight reinforcing member is used if the periphery of the electrode group is straight, and if the periphery of the electrode group has a curved line, a curved-line-like reinforcing member matching to this is used. The periphery of the electrode group and the reinforcing member may be contacted or may be spaced to a degree not to impair the effect of the present invention.

In addition, the third sheet may be enough as long as it is used to prevent shortcircuit between the electrodes, and it may be not only what is called a separator but also a polymer electrolyte or an inorganic solid electrolyte.

In addition, a second aspect of the present invention relates to the film-case-type electricity storage device, characterized in that: the electrode group is a winding-type electrode group obtained by laminating and winding the first electrode sheet, the second electrode sheet and the third sheet; a winding-type electrode group where a cross-section vertical to a winding axis in the winding-type electrode group is an ellipse shape; and the bar-like reinforcing member is provided along at least one of the peripheries at a longer diameter direction of the ellipse shaped cross-section.

It should be noted that “ellipse shape” in the present invention includes every one having a curved shape at the periphery, and thus includes not only complete ellipse but also what is called flat-like shape or oval-like shape.

By taking such a configuration, because the mechanical strength is enhanced by the reinforcing member provided along at least one of the peripheries at the longer diameter direction of the ellipse shaped cross-section in the above winding-type electrode group, the deformation of the winding-type electrode group in a winding axis direction can be suppressed. In particular, by providing the reinforcing member along each of the peripheries at the longer diameter direction of the ellipse shaped cross-section, the deformation in the winding axis direction can be suppressed still more.

In addition, in the case where the film case is constituted by a metal-laminated resin film, as compared with the case of constitution by other resin films, not only the air tightness but also the mechanical strength can be enhanced still more.

The film-case-type electricity storage device of the present invention can be suitably used as the electricity storage device made by containing a non-aqueous-type electrolytic solution, in which the first electrode sheet is a positive electrode, and the second electrode sheet is a negative electrode, and it is particularly preferable to be the electricity storage device in which the non-aqueous-type electrolytic solution includes lithium ions. In addition, it is particularly preferable that the film-case-type electricity storage device of the present invention is a secondary battery.

The film-case-type electricity storage device of the present invention can be produced easily and also, because of having higher mechanical strength as compared with the conventional ones, without the impairing advantage of light weight by using the film case as the external packaging, the deformation of the electricity storage device can be suppressed, and the shortcircuit can be prevented still more.

### BRIEF DESCRIPTION OF THE DRAWINGS

FIG. 1 is a drawing which illustrates a configuration of the electrode group to be used in the film-case-type electricity storage device of an embodiment of the present invention.

FIG. 2 is a perspective view of the film-case-type electricity storage device relevant to an embodiment of the present invention.

FIG. 3 is an A-A cross-sectional view of the film-case-type electricity storage device of FIG. 2.

FIG. 4 is a perspective view of the film-case-type electricity storage device relevant to another embodiment of the present invention.

FIG. 5 is a perspective view of the film-case-type electricity storage device relevant to another embodiment of the present invention.

FIG. 6 is a perspective view of the film-case-type electricity storage device relevant to another embodiment of the present invention.

FIG. 7 is a perspective view of a conventional film-case-type electricity storage device.

### DETAILED DESCRIPTION OF THE EMBODIMENTS

Explanation will be given below on suitable embodiments of the present invention with reference to drawings.

It should be noted that, as the film-case-type electricity storage device of the embodiment of the present invention, an exemplification will be shown below on the film-case-type lithium ion secondary battery, in which the winding-type electrode group with a flat cross-section of the winding axis, and two square bar-type reinforcing members provided at the both ends of the periphery of the relevant electrode group are stored in the airtight metal-laminated resin film case (hereafter referred to simply as “the film-case-type secondary battery”). However, the present invention should not be limited to the relevant embodiment, and can be applied to other batteries, or the film-case-type electricity storage devices other than battery such as a condenser or a capacitor.

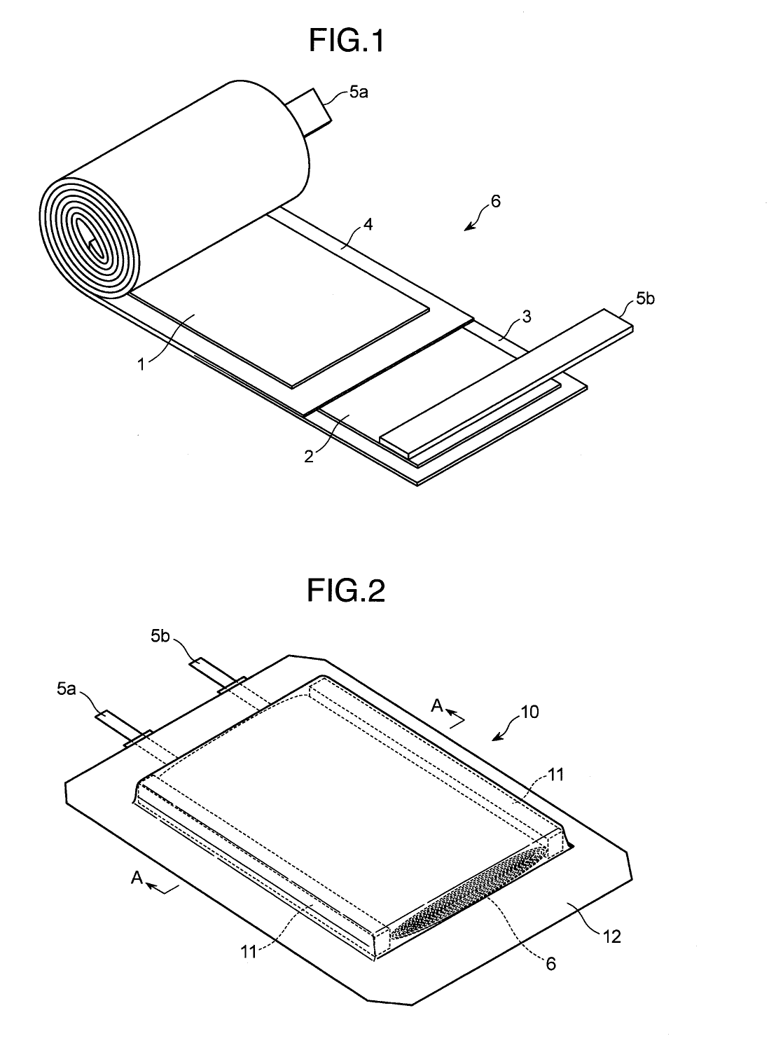

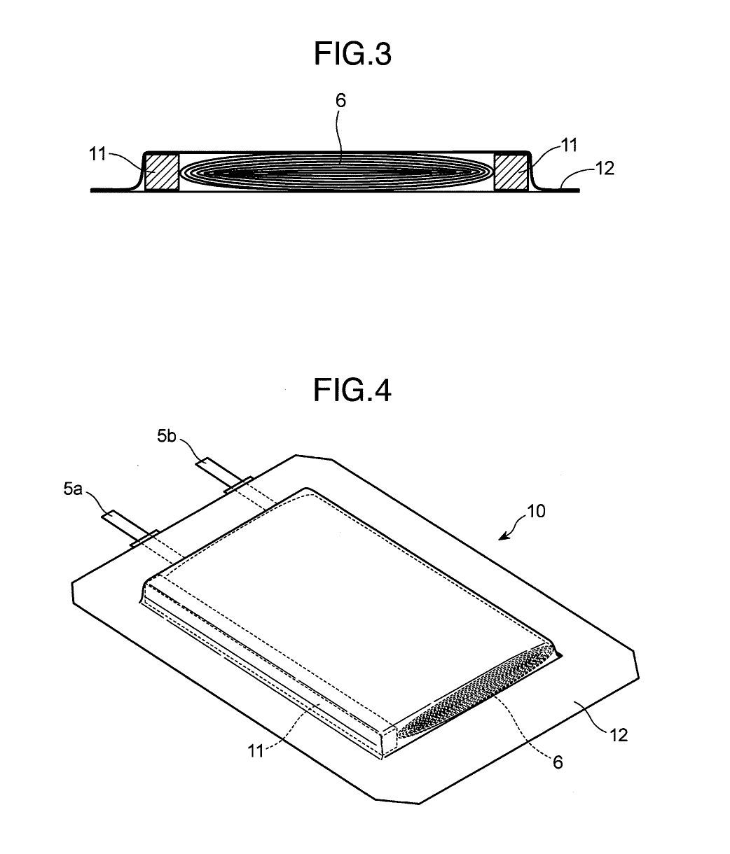

FIG. 1 is a drawing which illustrates a configuration of the electrode group to be used in the film-case-type electricity storage device of an embodiment of the present invention, FIG. 2 is a perspective view of the film-case-type electricity storage device relevant to an embodiment of the present invention, and FIG. 3 is an A-A cross-sectional view of the film-case-type electricity storage device of FIG. 2.

It should be noted that, in these drawings, for easier understanding of the structure of the electrode group, the thicknesses of the positive electrode, the negative electrode, the separator or the like, relative to the size of the electrode group, are represented larger than practical ones.

In FIG. 1, the winding-type electrode group 6 is composed of the first electrode sheet 1 adhered with an electrode tab 5a, the second electrode sheet 2 adhered with an electrode tab 5b, the tabs being each slender and long pieces along with a separator 3 and a separator 4, and it is the electrode group that after lamination and winding in the order of the separator 3, the second electrode sheet 2, the separator 4 and the first electrode sheet 1, the cross-section cut in a direction vertical to a winding axis is formed in flat-like shape by pressurization. The electrode group 6 after the winding is fixed with a tape or the like, and by impregnating an electrolyte solution containing lithium ions into the electrode group, and storing in a metal-laminated resin film case 12, it is used as the film-case-type lithium ion secondary battery illustrated in FIG. 2. It should be noted that, in the present embodiment, the size of the electrode group 6 is 5 to 500 mm in a longer diameter direction of the cross-section, 2 to 200 mm in a shorter diameter direction thereof, and 10 to 500 mm in a length direction.

The film-case-type battery 10 of the present embodiment of FIG. 2 is one where the above electrode group 6 and the two square bar-type reinforcing members 11 are stored in the film case 12, and it is produced by charging the electrolyte solution into the film case 12 which is the two metal-laminated resin films the four sides of which are heat-welded and stores the electrode group 6 and the reinforcing member 11, and after impregnating the electrolyte solution into the separators 3 and 4, extracting the excess electrolyte solution, and sealing the positive electrode tab 5a and the negative electrode tab 5b so as to be exposed outside, under reduced pressure.

The film-case-type secondary battery 10 can avoid the deformation in the winding axis direction, even when receiving stress from outside to the film-case-type secondary battery 10, by providing the square bar-type reinforcing members 11 at the both edge portions of the electrode group 6.

In addition, in the relevant film-case-type secondary battery 10, heat dissipation is not inhibited practically even in the case that the electrode group 6 emits heat by charging-discharging, because of a configuration arranged with the square bar-type reinforcing members 11 only at the periphery of the electrode group 6.

It should be noted that the shape of the reinforcing member should not be limited to the square bar-type of the present embodiment, and may be any shape such as a circular cylinder shape, a half circular cylinder shape, a triangular prism shape.

In the present embodiment, the reinforcing member 11 is composed of a reinforcing member made of polyethylene having sufficient strength. The reinforcing member may be any material as long as it is a material having higher hardness as compared with the electrode group and does not solve out into the electrolyte solution. In addition, it is preferably an insulating material. Specifically, an inorganic oxide such as alumina or silica, a polyolefin such as polyethylene or polypropylene, a fluorocarbon resin such as polytetrafluoroethylene, a resin having chemical resistance such as a silicone resin, or the like can be suitably used, as well as the above polyethylene. Among these, polyethylene used in the present embodiment is particularly suitable, because of having sufficient strength and light weight and suitable hardness, and thus providing little scratch the electrode group 6 or the metal-laminated resin film of the film case 12.

The film case 12 is a flat case in which the four sides of the two metal-laminated resin films are heat-welded. A metal layer constituting a film of the film case 12 may be any material, as long as it is capable of furnishing air tightness to the relevant film by suppressing the permeation of external air, and is made of a material such as aluminum, titanium or an alloy containing these, and aluminum is particularly preferable. As a resin layer of the film, any material having suitable flexibility and strength may be used, and a thermoplastic resin such as polyethylene, polypropylene, or polyethylene terephthalate can be suitably used. In addition, the metal layer and the resin layer of the metal-laminated resin film may be single layer or may be multi-layers.

The relevant film case may be any one as long as it is capable of ensuring air tightness, and the thickness thereof is determined depending on applications, in consideration of required mechanical strength and weight, however, it is usually from 100 to 500 μm.

It should be noted that, as the film case, any metal-laminated resin film case with any shape can be used, such as one obtained by heat-welding three sides after folding one sheet in two, or a bag-like one etc., as well as the case of the present embodiment in which the four sides of the two metal laminated resin films are heat-welded.

It should be noted that in the present embodiment, explanation was given on the winding-type electrode group having a flat shaped cross-section, however, it is not limited to this shape, and the electrode group having any shape can be used, such as the winding-type electrode group having a circular shaped or non-circular shaped cross-section, or the laminating-type electrode group having a laminated form of two kinds of the electrode sheets via the separator, or the like.

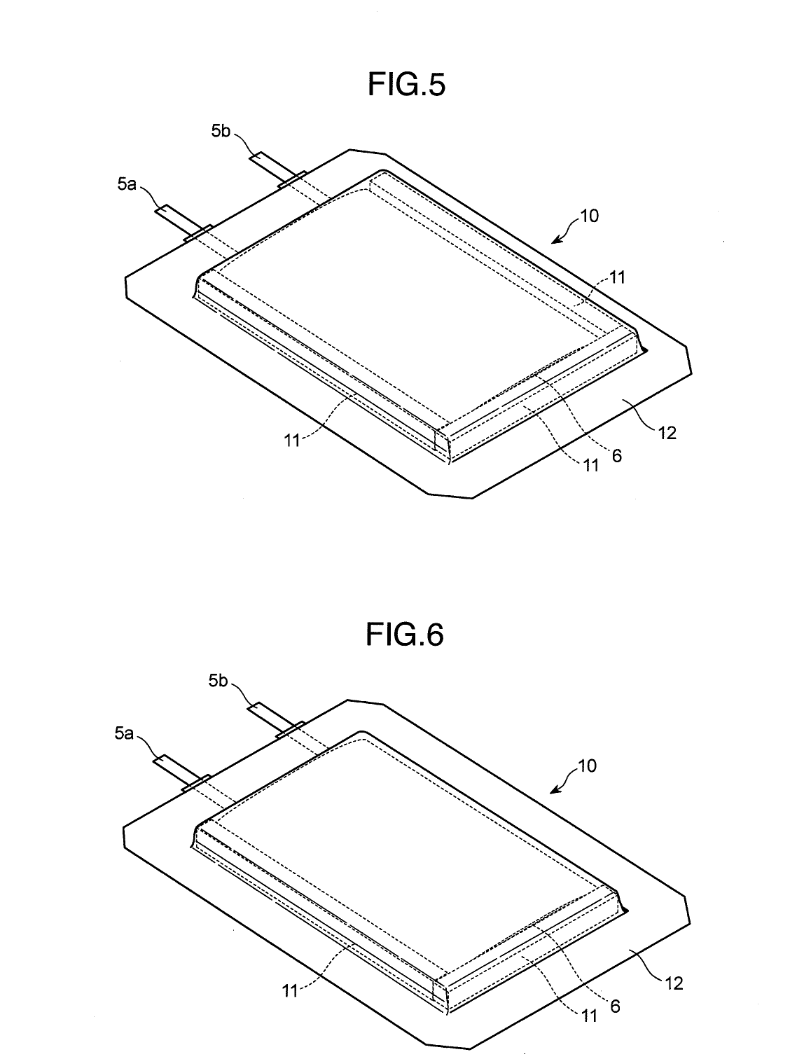

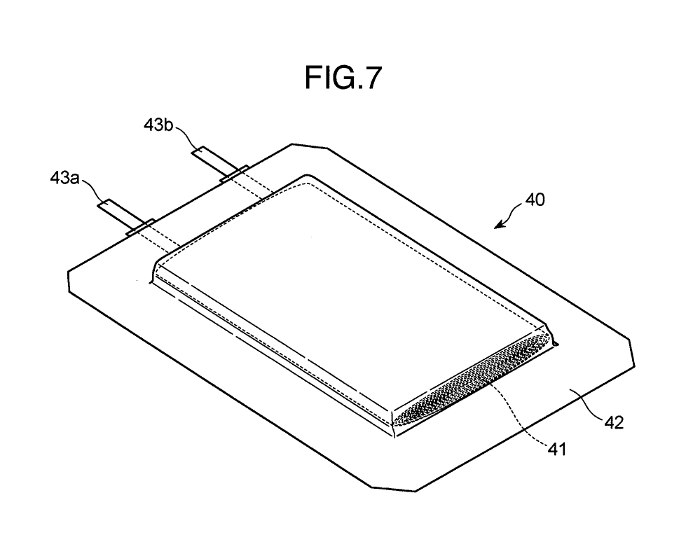

In addition, as illustrated in FIG. 2, in the present embodiment explanation was given on the form of arranging the two bar-type reinforcing members 11 so as to face the both edges of the curved portion (periphery) of the electrode group, however, it is not limited to this form, and the reinforcing member 11 may be arranged only at one edge of the curved part as illustrated in FIG. 4. In addition, the reinforcing member 11 may be arranged at the edge surface of the electrode group, or the reinforcing member 11 may be arranged in U-shape as illustrated in FIG. 5, or the reinforcing member 11 may be arranged in an L-shape as illustrated in FIG. 6.

On the other hand, the arrangement of the reinforcing member 11 in U-shape in FIG. 5 or in L-shape in FIG. 6 disturbs heat dissipation from the side surface (edge surface) in a direction vertical to the winding axis of the winding-type electrode group. Therefore, in the case of a high-output battery generating a large quantity of heat, it is desirable that the reinforcing member 11 is arranged only along the periphery at a longer diameter direction of the ellipse-shaped cross-section, as illustrated in FIG. 2 or FIG. 4.

Explanation will be given below on configuration elements of the electrode group to be used in the present invention.

In the electrode group 6 of the present embodiment illustrated in FIG. 1, the first electrode sheet 1 is an electrically conductive sheet produced by coating a positive electrode mixture containing a lithium-containing oxide as a positive electrode active material onto an Al foil, and has a function as a positive electrode. This positive electrode sheet (the first electrode sheet 1) is usually configured by a positive electrode collector and the positive electrode mixture supported on the positive electrode collector, and the thickness of the positive electrode sheet (the first electrode sheet 1) is usually about 5 to 500 μm.

As the positive electrode collector, Al is used in the present embodiment, however, it may be any material as long as it is easy to fabricate to a thin film, and a metal such as Ni or stainless steel can be used as well as Al. The shape of the positive electrode collector includes, for example, foil like, flat plate like, mesh like, net like, lath like, punching metal like, or emboss like, or combination thereof (for example, a mesh-type flat plate or the like).

The positive electrode mixture contains the positive electrode active material and an electrically conductive material or a binder, if necessary, and each of them can be produced using a conventionally known material.

The Li-containing oxide as the positive electrode active material can include, for example, LiCoO₂, LiNiO₂, Li(Ni, Co)O₂, Li(Ni, Mn)O₂, Li(Ni, Mn, Co)O₂, LiMn₂O₄, Li(Mn, Fe)₂O₄, LiFePO₄, LiMnPO₄ or the like, and they can be used as one kind or by mixing two or more kinds.

As the electrically conductive material, carbon material can be used, and as the carbon material, graphite powder, carbon black, fibrous carbon material such as carbon nanotube or the like can be included.

As the binder, a thermoplastic resin can be used, and for example, a fluorocarbon resin such as polyvinylidene fluoride (hereinafter sometimes abbreviated as PVDF), polytetrafluoroethylene (hereinafter sometimes abbreviated as PTFE), a polyolefin resin such as polyethylene or polypropylene is included. In addition, they may be used by mixing two or more kinds.

A method for supporting the positive electrode mixture onto the positive electrode collector includes a method for forming under compression, or a method for fixing it by making paste using an organic solvent or the like, applying it onto the positive electrode collector, and pressing it after drying or the like. A method for applying the positive electrode mixture onto the positive electrode collector includes, for example, a method of slit-die coating, a method of screen coating, a method of bar coating or the like.

In the present embodiment, the second electrode sheet 2 is an electrically conductive sheet produced by coating graphite (graphite powder) onto a Cu foil, and has a function as the negative electrode.

This negative electrode sheet (the second electrode sheet 2) can be produced usually by supporting the negative electrode material such as carbon material and, if necessary, the negative electrode mixture containing the binder or the electrically conductive material on the negative electrode collector. The thickness of the negative electrode sheet (the second electrode sheet 2) is usually about 5 to 500 μm.

As the negative electrode collector, in the present embodiment, Cu is used, however, other electrically conductive materials may be used as well, including, for example, Ni, stainless steel and the like. On the other hand, Cu is suitable, in that it hardly produces an alloy with lithium, and is easy to work to a thin film. In addition, the electrically conductive material and the binder can include a material similar to the above positive electrode sheet.

A method for supporting the negative electrode mixture on the negative electrode collector includes, similarly as in the case of the above positive electrode, a method of forming under compression, a method of making paste using a solvent or the like, applying onto the negative electrode collector, pressing after drying and fixing, or the like.

It should be noted that, in order to taking electric current in and out, Cu is used in the present embodiment as the electrode tabs 5a and 5b adhered onto the first electrode sheet 1 and the second electrode sheet 2. However, it may be any material, as long as it is a material having sufficient electric conductivity, including Cu, Ni, stainless steel or the like. In addition, an electrode tab composed of a known material can be used as well. Further, a method for adhering the electrode sheet and the electrode tab 5 is not particularly limited, and usually it is carried out by welding.

As the separator 3 and the separator 4 (the third sheet), a porous polyethylene sheet with a thickness of 10 to 30 μm is used, wherein a suitable amount of the electrolyte solution is filled. The thickness of the separator is not particularly limited, and is usually 5 to 200 μm (suitably 5 to 40 μm).

It is desirable that the separators 3 and 4 (the third sheet) are made of a thermoplastic resin, and a porous polyethylene sheet was used in the present embodiment, however, it may be a porous sheet made of other material, and as the other material, specifically, a polyolefin resin such as polyethylene, or polypropylene, a fluorocarbon resin; and a nitrogen-containing aromatic polymer are included.

In addition, the separators 3 and 4 (the third sheet) have a function to prevent the shortcircuit of the both electrode sheets and a shutdown function in an overcharged state, and to furnish a function to suppress film fracture caused by heat (heat resistant function) after the shutdown, there can be used also a laminated separator in which a heat resistant porous layer having heat resistance and a porous sheet containing a thermoplastic resin such as polyethylene resin are laminated. The heat resistant porous layer may be composed of a heat resistant resin, or may be composed of inorganic particles, or may be composed of these mixtures. As the heat resistant resin, it is preferable to use the nitrogen-containing aromatic polymer, and as the laminated separator, the laminated separator in which the heat resistant porous layer having the nitrogen-containing aromatic polymer and a porous polyethylene sheet are laminated, is suitable in view of heat resistance as the separator for the secondary battery and in view of shutdown performance. As the laminated separator, those described in, for example JP-A-2000-30686, JP-A-10-324758 and so forth can be cited.

As the electrolyte solution, a conventionally known non-aqueous-type electrolyte solution is used, and the non-aqueous-type electrolyte solution usually contains an electrolyte and an organic solvent. In the case of the film-case-type secondary battery of in the present embodiment, the electrolyte may be any one generally used in the lithium ion secondary battery, and includes, for example, a lithium salt such as LiClO₄, LiPF₆, LiAsF₆, LiSbF₆, LiBF₄, LiCF₃SO₃, LiN(SO₂CF₃)₂, LiN (SO₂C₂F₅)₂, LiN(SO₂CF₃)(COCF₃), Li(C₄F₉SO₃), LiC(SO₂CF₃)₃, Li₂B₁₀Cl₁₀, LiBOB (here, BOB represents bis(oxalato)borate), and lithium lower aliphatic carboxylate or LiAlCl₄, and a mixture of two or more kinds thereof may be used as well. In view of enhancing the battery capacity, it is preferable to use, as the electrolyte, at least one or more kinds of fluorine compounds selected from the group consisting of LiPF₆, LiAsF₆, LiSbF₆, LiBF₄, LiCF₃SO₃, LiN(SO₂CF₃)₂ and LiC(SO₂CF₃)₃. In addition, the organic solvent includes carbonate, for example, propylene carbonate (PC), ethylene carbonate (EC), dimethyl carbonate (DMC), diethyl carbonate (DEC), ethyl methyl carbonate (EMC), 4-trifluoromethyl-1,3-dioxolane-2-one, 1,2-di(methoxycarbonyl)ethane, and two or more kinds thereof may be used by mixing. Among carbonates, use of a mixed solvent containing ethylene carbonate (EC), dimethyl carbonate (DMC), and ethyl methyl carbonate (EMC) is preferable, in view of being persistent.

The film-case-type electricity storage device of the present invention can be produced easily and because of having higher mechanical strength as compared with a conventional one, without impairing the advantage of light weight attained by using the film case as the external packaging, the deformation of the device can be suppressed, and the shortcircuit can be prevented. Therefore, it can endure a long period of service as well, so that it is industrially extremely promising.

1. A film case type electricity storage device, comprising an airtight film case storing an electrode group obtained by laminating or laminating and winding a first electrode sheet, a second electrode sheet and a third sheet, and a bar-like reinforcing member provided along the periphery of said electrode group.

2. The film case type electricity storage device according to claim 1, wherein
said electrode group is a winding-type electrode group obtained by laminating and winding the first electrode sheet, the second electrode sheet, and the third sheet;
a cross-section vertical to a winding axis in said winding-type electrode group is ellipse shape; and
said bar-like reinforcing member is provided along at least one direction of the peripheries at a longer diameter direction of said ellipse shaped cross-section.

3. The film case type electricity storage device according to claim 2, wherein said bar-like reinforcing member is provided along each of the peripheries at a longer diameter direction of said ellipse shaped cross-section.

4. The electricity storage device according to claim 1, wherein said film case is made of a metal laminated resin film.

5. The electricity storage device according to claim 1, wherein the first electrode sheet configures a positive electrode, the second electrode sheet configures a negative electrode, and a non-aqueous-type electrolytic solution is contained.

6. The electricity storage device according to claim 5, wherein said non-aqueous-type electrolytic solution comprises lithium ions.

7. A secondary battery comprising the electricity storage device according to claim 1.
